(19) United States
(12) Patent Application Publication
(10) Pub. No.: US 2026/0093579 A1
(43) Pub. Date: Apr. 2, 2026

(54) ERROR CORRECTION CODE (ECC) INITIALIZATION ENGINE FOR MEMORIES

(71) Applicant: QUALCOMM Incorporated, San Diego, CA (US)

(72) Inventors: Prashant SINGH, Kanpur (IN); Deepak BARANWAL, Greater Noida (IN); Gurudeep BHAT, San Diego, CA (US); Rohit MEHANDIRATTA, HYDERABAD (IN)

(21) Appl. No.: 18/900,246

(22) Filed: Sep. 27, 2024

(51) Int. Cl. G06F 11/10

(52) U.S. Cl. CPC G06F 11/1068; G06F 11/1004

(57) ABSTRACT

Aspects of the present disclosure relate to error correction code (ECC) initialization of a memory of a safety domain in a system-on-a-chip (SoC). For example, the memory of the safety domain may be segmented into multiple memory banks. The multiple memory banks are associated with multiple ECC initialization engines. The multiple ECC initialization engines are simultaneously executed to perform concurrent ECC initialization of the multiple memory banks.

### BACKGROUND

### FIELD OF THE DISCLOSURE

Aspects of the present disclosure relate generally to error correction code (ECC) initialization process, and more particularly to, simultaneous ECC initialization of multiple memories in a system-on-a-chip (SoC) in an automobile.

### DESCRIPTION OF RELATED ART

Over the past several years, an automobile has been transformed from a self-propelled mechanical vehicle into a powerful and complex electro-mechanical system that includes a large number of sensors and processors that control many of the vehicle’s functions, features, and operations. Vehicles may be equipped with a vehicle control system, which may be configured to collect and use information from the vehicle’s various systems and sensors to automate all or a portion of the vehicle’s operations. For example, an Advanced Driver Assistance System (ADAS) may automate, adapt, or enhance the vehicle’s operations. The ADAS may use information collected from the sensors (e.g., accelerometer, geospatial positioning, etc.) to automatically detect a potential road hazard, and assume control over all or a portion of the vehicle’s operations (e.g., braking, steering, etc.) to avoid detected hazards. Features and functions commonly associated with an ADAS include adaptive cruise control, automated lane detection, lane departure warning, automated steering, automated braking, and automated collision avoidance. The vehicle monitors for errors associated with the control system, and the vehicle may notify the operator of such errors, shut down certain systems, or operate in a degraded state in response to detecting certain errors.

The vehicle control system may include memory chips. The memory chips may use an error correction code (ECC) to detect and correct bit errors. The ECC may be used with a non-volatile flash memory as well as volatile random access memory (RAM) memory. The ECC works by generating and storing an ECC code on memory writes, and verify such code on reads. Due to this process, ECC memory can only be read after it is written.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide the advantages described herein.

Certain aspects of the present disclosure provide a method for segmenting a memory of a safety domain in a system-on-a-chip (SoC) into a plurality of memory banks. The plurality of memory banks are associated with a plurality of error correction code (ECC) initialization engines. The method may further include simultaneously executing the plurality of ECC initialization engines to perform concurrent ECC initialization of one or more portions of the plurality of memory banks.

Certain aspects of the present disclosure provide an apparatus including a safety domain with a memory and one or more processors coupled to the safety domain. The one or more processors are configured to segment the memory of the safety domain into a plurality of memory banks. The plurality of memory banks are associated with a plurality of ECC initialization engines. The one or more processors are further configured to simultaneously execute the plurality of ECC initialization engines to perform concurrent ECC initialization of one or more portions of the plurality of memory banks.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be by reference to aspects, some of which are illustrated in the appended drawings. It is to be noted, however, that the appended drawings illustrate only certain aspects of this disclosure and are therefore not to be considered limiting of its scope, for the description may admit to other equally effective aspects.

FIG. 1 is a diagram of an example vehicle with a vehicle control system, in which aspects of the present disclosure may be practiced.

FIG. 2 is a block diagram of example components and interconnections in a system-on-a-chip (SoC), in which aspects of the present disclosure may be practiced.

FIG. 3 is a block diagram of an example SoC-based electronic control unit (ECU) in communication with one or more other ECUs, in which aspects of the present disclosure may be practiced.

FIG. 4 depicts an example boot process.

FIG. 5 illustrates example error correcting code (ECC) initialization of a memory bank in a SoC using an ECC initialization engine, in accordance with certain aspects of the present disclosure.

FIG. 6 illustrates example concurrent ECC initialization of multiple memory banks in a SoC using multiple ECC initialization engines, in accordance with certain aspects of the present disclosure.

FIG. 7 depicts an example process illustrating triggering of concurrent ECC initialization of multiple memory banks in a SoC based on an execution of a primary bootloader (PBL), in accordance with certain aspects of the present disclosure.

FIG. 8 depicts an example method for ECC initialization of memory banks in a SoC, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Error correction code (ECC) is a way to detect and correct errors introduced by noise when data is read or transmitted. The ECC includes a wide array of ways to deal with the errors. For example, the ECC may be a hamming code, which can correct one error and detect two errors. This “single-error-correct, double-error-detect” approach is abbreviated SECDED.

ECC memory initialization refers to a process of setting up and configuring an ECC memory so that it can detect and correct errors in data stored in a random access memory (RAM). The ECC memory is designed to improve reliability and stability of a system by automatically correcting single-bit errors and detecting multi-bit errors.

A vehicle may include a vehicle control system. The vehicle control system may include one or more computing devices having system-on-a-chips (SoCs). A SoC refers to an integrated electronic device including one or more integrated circuit (IC) dies (e.g., chiplets), which combines multiple electronic components (e.g., processors, memories) on a single substrate or in a single package.

The SoC may include multiple processing domains such as a safety domain (also referred to as a “safety island (SAIL)”). The safety domain may be configured to support vehicle operations of the vehicle up to a lower, a same, or a higher automotive safety integrity level (ASIL). The safety domain may include a central processing unit (CPU) and a memory. The memory may be a static random access memory (SRAM), which has a large size as a main memory for the CPU.

The SRAM is ECC protected. So, the SRAM has to be initialized before being used, so that any random read/write operations on the SRAM do not trigger any ECC faults in the SRAM. For example, at a time of a boot process of the safety domain (e.g., which involves a series of steps that may transition the safety domain from a powered-off state to a fully operational state), a software-based initialization of the SRAM is performed. The software-based initialization of the SRAM may take some time (e.g., around 5-10 milliseconds). At least some steps or tasks of the boot process may proceed only after the software-based initialization of the SRAM is completed. For example, once the boot process is started along with the software-based initialization of the SRAM, some tasks of the boot process are implemented only after the completion of the software-based initialization of the SRAM. Accordingly, this additional time of 5-10 milliseconds increases an overall time (e.g., a boot time) for the completion of the boot process, which may have a significant negative effect for operations related to the vehicle. The time taken for the software-based initialization of the SRAM may be reduced or optimized by adding dedicated hardware for the initialization of the SRAM.

Techniques proposed herein relate to ECC initialization of a memory (e.g., a SRAM) of a safety domain in a SoC in an optimal amount of time. For example, the SRAM may be divided into multiple memory banks of a smaller size. For each memory bank of the SRAM, a dedicated hardware engine (e.g., an ECC initialization engine) may be provided for the ECC initialization of the memory bank of the SRAM. The ECC initialization engine may perform the ECC initialization of the memory bank of the SRAM in a shorter amount of time than the ECC initialization of a full SRAM (e.g., since the memory bank has a smaller size than the full SRAM).

Also, multiple ECC initialization engines for the multiple memory banks of the SRAM may be executed or run in parallel (e.g., for their respective memory banks) at a same time. The simultaneous ECC initialization of the multiple memory banks of the SRAM, instead of the ECC initialization of the full SRAM, may save on a total time to initialize the full SRAM.

Particular aspects of the subject matter described in this disclosure can be implemented to realize one or more of the following potential advantages. In some examples, the described techniques provide overall time saving for boot processing, and flexibility to tune and improve performance by running the ECC initialization engines in parallel for the multiple memory banks of the SRAM.

### Example Vehicle Control System

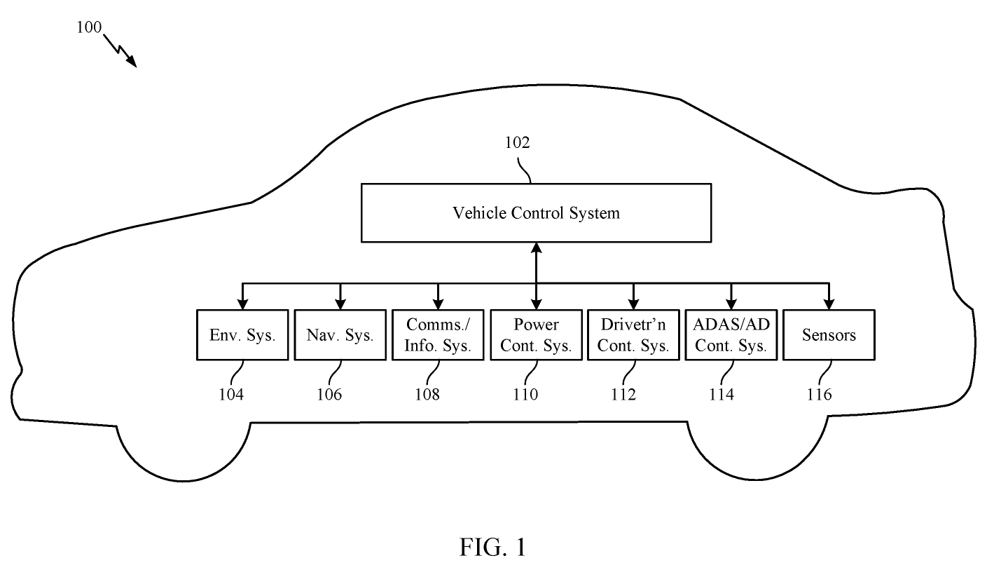

FIG. 1 is a block diagram of an example vehicle 100 including a vehicle control system 102 and various sensors suitable for controlling certain systems, such as an advanced driver assistance system (ADAS), automated driving (AD), and/or in-vehicle infotainment (IVI). The vehicle 100 may refer to a means of carrying or transporting something (e.g., a person and/or cargo). In some aspects, the vehicle 100 may represent a motor vehicle, such as a car, van, truck, semi-trailer truck, motorcycle, motorbike, moped, electric bicycle, etc. The vehicle 100 may be a series production road vehicle having safety-related systems that include one or more electrical and/or electronic systems, as further described herein. The vehicle 100 may use an internal combustion engine, an electric motor, or a hybrid propulsion system (e.g., a combination of an engine and an electric motor) for propulsion. In some cases, the vehicle 100 may have one or more electrical and/or electronic systems that comply with certain functional safety standards, such as ISO 26262 as provided by the International Organization for Standardization (ISO).

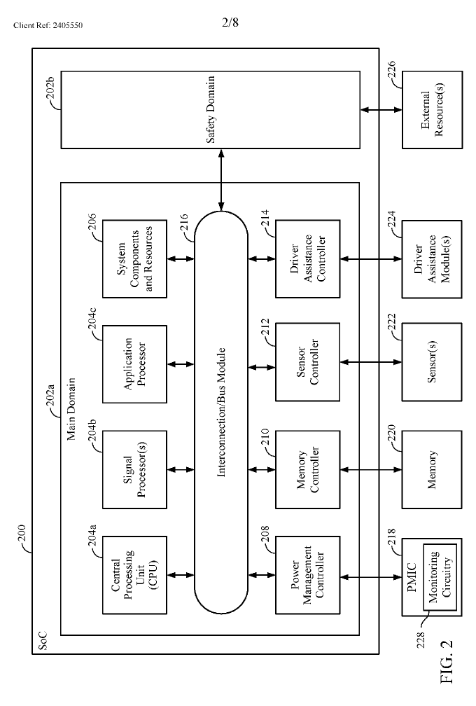

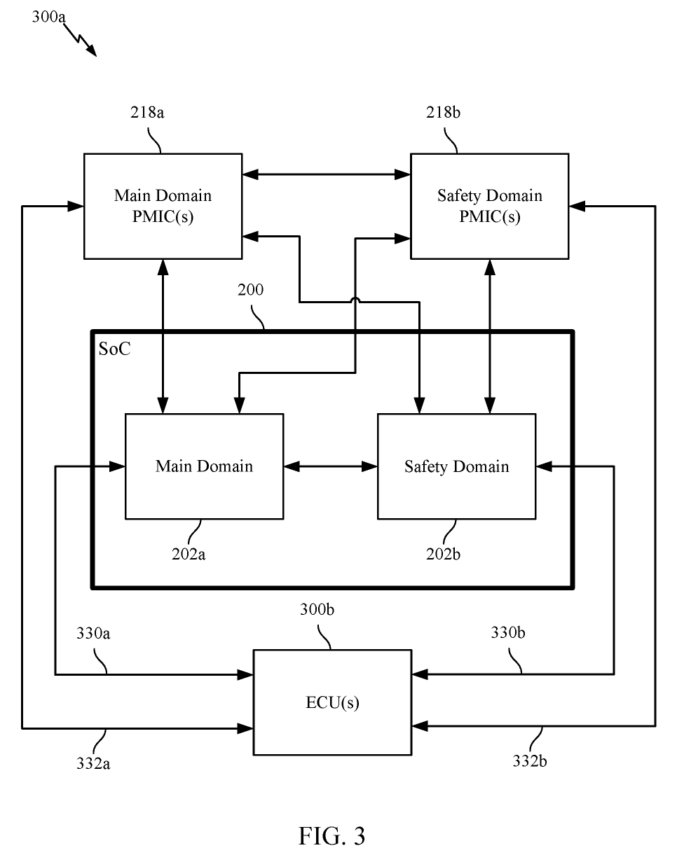

The vehicle 100 may include a vehicle control system 102, which may include one or more computing devices having system-on-a-chips (SoCs) (e.g., one or more electronic control units (ECUs)) as further described herein with respect to FIGS. 2 and 3. The vehicle control system 102 may be coupled to a variety of vehicle systems and subsystems, such as an environmental system 104 (e.g., an air conditioning and/or heating system), a navigation system 106, a communications and/or infotainment system 108, a power control system 110, a drivetrain control system 112, a driver assistance and/or automated driving control system 114, and/or a variety of sensors 116. Each vehicle system or subsystem may communicate with one or more other systems (and/or subsystem(s)) via one or more communication links, which may include wired communication links (e.g., a Controller Area Network (CAN) protocol compliant bus, Universal Serial Bus (USB) connection, Ethernet connection, universal asynchronous receiver-transmitter (UART), etc.) and/or wireless communication links (e.g., a Wi-Fi® link, Bluetooth® link, ZigBee® link, ANT+® link, etc.).

The vehicle control system 102 may perform certain operations associated with any of the vehicle systems and subsystems. For example, the vehicle control system 102 may control or initiate the power-on and/or shutdown sequence for any of the vehicle systems and subsystems. The vehicle control system 102 may monitor for errors associated with any of the vehicle systems and subsystems, and in some cases, the vehicle control system 102 may store the errors for vehicle diagnostics. In response to any errors detected, the vehicle control system 102 may perform certain actions, such as shutting down the affected system or transferring some of the affected operations to be performed at a different vehicle system. The vehicle control system 102 may monitor the power levels supplied to any of the vehicle systems and subsystems and ensure that the power levels supplied satisfy the operating specifications for any of the vehicle systems and subsystems.

The environmental system 104 may control the cooling and/or heating systems associated with the vehicle 100. For example, the vehicle 100 may have an air conditioning system, a heating system, heated or cooled seat(s), and/or a heated steering wheel, and the environmental system 104 may adjust the temperature according to user (or default) settings for the respective cooling and/or heating components. The navigation system 106 may show the vehicle’s location on a map and provide navigation information, such as directions to a destination, via a display and/or a speaker (neither shown).

The communications and/or infotainment system 108 may allow the user to access various information (e.g., navigation information, interior or exterior environmental information, ADAS information, etc.), applications, and/or entertainment or media content, such as music and/or videos. The communications and/or infotainment system 108 may allow the user to update or access settings associated with a variety of systems, such as the environmental system 104, the navigation system 106, ADAS, vehicle settings, etc. The communications and/or infotainment system 108 may allow the user and/or vehicle 100 to wirelessly communicate via an integrated modem of the vehicle or via the user’s wireless communication device (e.g., a smartphone or tablet).

The power control system 110 may control the components that output power to move the vehicle, such as an internal combustion engine (e.g., adjusting the air-fuel ratio, boost pressure, valve timing, etc.), an electric power system (e.g., controlling regenerative braking, battery power output, battery charging, battery cooling, etc.), and/or a hybrid power system (e.g., controlling regenerative braking, switching between battery power and engine power, battery charging, battery cooling, etc.). The drivetrain control system 112 may control the various components of the vehicle 100 that deliver power to the drive wheels. For example, the drivetrain control system 112 may control gear shifting in an automatic transmission. For a four-wheel drive vehicle, the drivetrain control system 112 may control the power ratio applied to the front and rear drive wheels.

The driver assistance and/or automated driving control system 114 may control various driver assistance features and functions, such as adaptive cruise control, automated lane detection, lane departure warning, automated steering, automated braking, and automated collision avoidance. The driver assistance and/or automated driving control system 114 may control automated driving at various levels of automation, such as any of the Society of Automotive Engineers (SAE) levels 1 through 5.

The variety of sensors 116 coupled to the vehicle control system 102 may include a speedometer, a wheel speed sensor, a torquemeter, a turbine speed sensor, a variable reluctance sensor, a sonar system, a radio detection and ranging (RADAR) system, an air-fuel ratio meter, a water-in-fuel sensor, an oxygen sensor, a crankshaft position sensor, a curb feeler, a temperature sensor, a Hall effect sensor, a manifold absolute pressure sensor, various fluid sensors (e.g., engine coolant sensor, transmission fluid sensor, etc.), a tire-pressure monitoring sensor, a mass airflow sensor, a speed sensor, a blind spot monitoring sensor, a parking sensor, cameras, microphones, accelerometers, compasses, a global navigation satellite system (GNSS) receiver (e.g., a global positioning system (GPS) receiver or a Galileo receiver), and other similar sensors for monitoring physical or environmental conditions in and around the vehicle.

The aforementioned systems are presented merely as examples, and vehicles may include one or more additional systems that are not illustrated for clarity. Additional systems may include systems related to additional other functions of the vehicular system, including instrumentation, airbags, cruise control, other engine systems, stability control parking systems, tire pressure monitoring, antilock braking, active suspension, battery level and/or management, and a variety of other systems.

### Example System-On-A-Chip

As used herein, the term “system-on-a-chip” (SoC) generally refers to an integrated electronic device comprising one or more integrated circuit (IC) dies (e.g., chiplets), which combines multiple electronic components (e.g., processors and/or memory) on a single substrate or in a single package. A single SoC may contain circuitry for digital, analog, mixed-signal, and/or radio-frequency functions. A single SoC may also include any number of general purpose and/or specialized processors (digital signal processors, modem processors, video processors, etc.), memory blocks (e.g., ROM, RAM, DRAM, flash, etc.), and resources (e.g., timers, voltage regulators, oscillators, etc.). A SoC may also include software for controlling the integrated resources and processors, as well as for controlling peripheral devices.

FIG. 2 is a block diagram of example components and interconnections in a SoC 200 suitable for implementing various aspects of the present disclosure. The SoC 200 may include multiple processing domains having, for example, at least one main domain 202a and at least one safety domain 202b (also referred to as a “safety island (SAIL)”). In the case of multiple main (or safety) domains, the main (or safety) domains may be similar to one another. For ease of description and illustration, the remainder of the disclosure may refer to a main domain 202a and a safety domain 202b, but the reader is to understand that there may be more than one main domain and/or more than one safety domain.

The main domain 202a may be configured to support (or be capable of performing) vehicle operations (e.g., driver assistance and/or automated driving operations, features, etc.) up to a specific automotive safety integrity level (ASIL), and the safety domain 202b may be configured to support (or be capable of performing) vehicle operations up to a lower, the same, or a higher ASIL than the main domain 202a. For example, the main domain 202a may be configured to support (or be capable of performing) vehicle operations up to an ASIL B, and the safety domain 202b may be configured to support vehicle operations up to an ASIL D. In some cases, the main domain 202a may be configured to support (or be capable of performing) vehicle operations up to an ASIL A, B, C, or D, and the safety domain 202b may be configured to support vehicle operations up to a different ASIL than the main domain 202a. In certain cases, the main domain 202a and the safety domain 202b may be configured to support (or be capable of performing) vehicle operations at the same ASIL (e.g., ASIL D). The main domain 202a and the safety domain 202b may be configured to support (or be capable of performing) vehicle operations at different ASILs.

The ASILs may be defined in a specific safety standard, such as ISO 26262. For example, the ASILs may provide a risk classification scheme for certain electrical and electronic systems of road vehicles. ISO 26262 provides four ASILs including ASIL A, ASIL B, ASIL C, and ASIL D. ASIL D is the highest classification and corresponds to the highest level of safety measures for avoiding an unreasonable residual risk, and ASIL A is the lowest classification and corresponds to the lowest level of safety measures.

In certain aspects, the SoC 200 may be included in a computing device (e.g., an ECU) in a vehicle control system. The SoC 200 may control any of the systems described herein with respect FIG. 1. For example, the SoC 200 may be configured to control an ADAS/AD system, such as the driver assistance and/or automated driving control system 114 described herein with respect to FIG. 1. In certain aspects, the SoC 200 may be in communication with other ECU(s) in a vehicle control system, and the SoC 200 and/or a PMIC 218 may report errors associated with the SoC 200 to the other ECU(s), as further described herein with respect to FIG. 3. For example, the main domain 202a may control the environmental system, the infotainment system, and driver assistance features up to a certain ASIL, and the safety domain 202b may control driver assistance features up to a certain ASIL, which may typically be higher than the main domain 202a.

The main domain 202a and/or safety domain 202b may include a number of heterogeneous processors 204a-c (collectively referred to herein as “processors 204”), such as a central processing unit (CPU) 204a, signal processor(s) 204b (e.g., a digital signal processor, an image signal processor, a neural network signal processor, etc.), and/or an application processor 204c. Each processor 204 may include one or more cores, and each processor/core may perform operations independent of the other processors/cores. Each processor 204 may be part of a subsystem (not shown) including one or more processors, caches, etc. configured to handle certain types of tasks or computations. It should be noted that the main domain 202a and/or safety domain 202b may include additional processors (not shown) or may include fewer processors (not shown). The main domain 202a and/or safety domain 202b may include other processors (e.g., a graphics processing unit (GPU), a vision processing unit, etc.) in addition to or instead of those illustrated.

The main domain 202a and/or safety domain 202b may include system components and resources 206 for performing certain specialized operations, such as analog-to-digital conversions and/or wireless data transmissions. The system components and resources 206 may include components such as voltage regulators, oscillators, phase-locked loops (PLLs), modems, peripheral bridges, data controllers, system controllers, access ports, timers, and other similar components used to support the processors and software clients running on the SoC 200. The system components and resources 206 may include circuitry for interfacing with peripheral devices, such as cameras, electronic displays, wireless communication devices, external memory chips, etc.

The main domain 202a and/or safety domain 202b may further include a power management controller 208, a memory controller 210 (e.g., a dynamic random access memory (DRAM) memory controller and/or a non-volatile memory controller), a sensor controller 212, and/or a driver assistance controller 214. The main domain 202a and/or safety domain 202b may also include an input/output (IO) module (not shown) for communicating with resources external to the SoC, such as a clock and a voltage regulator, each of which may be shared by two or more of the internal SoC components. The IO module may include a general purpose IO (GPIO) interface, for example. In certain aspects, each of the main domain 202a and the safety domain 202b may have a separate clock and power supply to facilitate independent operability.

The processors 204 of the main domain 202a may be interconnected to the system components and resources 206, the power management controller 208, the memory controller 210, the sensor controller 212, the driver assistance controller 214, other system components, and/or the safety domain 202b via an interconnection/bus module 216, which may include an array of reconfigurable logic gates and/or implement a bus architecture (e.g., CoreConnect, advanced microcontroller bus architecture (AMBA), etc.). Communications may be provided by advanced interconnects, such as high performance networks-on-chip (NoCs).

The interconnection/bus module 216 may include or provide a bus mastering system configured to grant SoC components (e.g., processors, peripherals, etc.) exclusive control of the bus (e.g., to transfer data) for a set duration, number of operations, number of bytes, etc. In certain aspects, the interconnection/bus module 216 may include a direct memory access (DMA) controller (not shown) that enables components connected to the interconnection/bus module 216 to operate as a master component and initiate memory transactions. The interconnection/bus module 216 may implement an arbitration scheme to prevent multiple master components from attempting to drive the bus simultaneously.

The power management controller 208 may manage the power supplied to the main domain 202a from a PMIC 218, which may be representative of one or more PMIC(s). In some cases, the power management controller 208 may report errors associated with the main domain 202a and/or safety domain 202b to the PMIC 218, as further described herein. The power management and error monitoring control may be separate and independent between the main domain 202a and the safety domain 202b.

The memory controller 210 may be a specialized hardware module configured to manage the flow of data to and from a memory 220. The memory controller 210 may include logic for interfacing with the memory 220, such as selecting a row and column in a cell array of the memory 220 corresponding to a memory location, reading or writing data to the memory location, etc. The memory 220 may be an on-chip component (e.g., on the substrate, die, integrated chip, etc.) of the SoC 200, or alternatively (as shown) an off-chip component.

The sensor controller 212 may manage the sensor data received from various sensors 222, such as the sensors 116. The sensor controller 212 may include circuitry for interfacing with the sensors 222. For example, the sensor controller 212 may receive sensor data from a tire pressure monitoring system and/or a sensor used for adaptive cruise control.

The driver assistance controller 214 may control certain driver assistance functions via a driver assistance module 224 (e.g., one or more actuators, relays, switches, etc.). For example, the driver assistance controller 214 may control the adaptive cruise control by controlling actuators coupled to the engine and/or braking system. In some cases, the driver assistance controller 214 may perform automated steering by controlling actuators attached to the steering system. It will be appreciated that the driver assistance controller 214 is merely an example, and the main domain 202a and/or the safety domain 202b may include a controller that interfaces with automated driving components in addition to or instead of the driver assistance controller 214.

The SoC 200 may also include additional hardware and/or software components that are suitable for collecting sensor data from sensors, including speakers, user interface elements (e.g., input buttons, touch screen display, etc.), microphone arrays, sensors for monitoring physical conditions (e.g., location, direction, motion, orientation, vibration, pressure, temperature, etc.), cameras, compasses, GPS receivers, communications circuitry (e.g., Bluetooth®, wireless local area network (WLAN), Long Term Evolution (LTE), Fifth Generation New Radio (5G NR), etc.), and other well-known components (e.g., accelerometer, etc.) of modern electronic devices.

Each of the processing domains may operate independently of the other domains. In some cases, each of the processing domains may be coupled to separate and independent external resources, such as a PMIC, memory, sensor(s), and driver assistance module(s). A particular external resource may be designed in accordance with an ASIL corresponding to the particular ASIL associated with the main domain 202a and/or the safety domain 202b to which the external resource is coupled. For example, the PMIC 218 may have the same ASIL as the main domain 202a, and the PMIC that provides power to the safety domain 202b may have the same ASIL as the safety domain 202b. The safety domain 202b may include the same or different processing resources and components as the main domain 202a as described herein with respect to the main domain 202a. For example, the safety domain 202b may include the processors 204, the system components and resources 206, the power management controller 208, the memory controller 210, the sensor controller 212, and the driver assistance controller 214. The safety domain 202b may be coupled to certain external resource(s) 226, which may be representative of a PMIC, memory, sensors, and/or driver assistance module, for example, as described herein with respect to the main domain 202a.

In addition to the SoC 200 discussed above, various aspects may be implemented in a wide variety of computing systems, which may include a single processor, multiple processors, multicore processors, or any combination thereof. Various aspects described herein may also be implemented in systems that employ more than one SoC. For example, a SoC-based ECU may include multiple SoCs (e.g., SoCs 200) configured to monitor the safety of a vehicle control system (e.g., vehicle control system 102). In these examples, each of the multiple SoC(s) may include different numbers of main domains and/or safety domains.

FIG. 3 is a block diagram of an example SoC-based ECU 300a in communication with one or more other ECUs 300b, for example, for safety monitoring. In this example, the ECU 300a and the other ECU(s) 300b may operate in a vehicle control system and/or any vehicle system or subsystem, as described herein with respect to FIG. 1. The ECU 300a may perform some vehicle control operations (e.g., infotainment, environmental, ADAS, etc.), and the other ECU(s) 300b may perform some vehicle control operations (e.g., system wide controls, engine controls, drivetrain controls, other ADAS features, etc.). As an example, the ECU 300a may be an ADAS ECU. The ECU 300a may include the SoC 200 and corresponding external resources as described herein with respect to FIG. 2. In some aspects, the other ECU(s) 300b may include a SoC-based ECU, such as the SoC 200 and corresponding external resources as described herein with respect to FIG. 2.

The main domain 202a may operate independently of the safety domain 202b with independent external resources. For example, the main domain 202a may receive power from main domain PMIC(s) 218a, and the safety domain 202b may receive power from safety domain PMIC(s) 218b, which are different from the main domain PMIC(s) 218a and may provide independent power. Such a power architecture may allow the main domain 202a to operate even while the safety domain 202b is shut down or in a low power state, or vice versa. In some cases, the safety domain 202b may be operational to monitor the main domain 202a for errors.

Any of the main domain 202a, the safety domain 202b, the main domain PMIC(s) 218a, and/or the safety domain PMIC(s) 218b may perform self-error detection, where the component may detect an error that occurs at the component. For example, the main domain 202a may detect an error that occurs at the main domain 202a. These components may also perform redundant error detection as further described herein, where the component may detect an error that occurs at another component. For example, the safety domain 202b may detect an error that occurs at the main domain 202a, or vice versa. The safety domain 202b may monitor a safety subsystem of the main domain 202a for errors. The ECU 300a may use a redundant error propagation scheme, where any errors detected within safety subsystems are routed to the main domain 202a and the safety domain 202b. For example, the safety domain PMIC(s) 218b may notify the main domain 202a of the occurrence of an error associated with the safety domain 202b or the occurrence of an error within the safety domain PMIC(s) 218b.

### Example Error Correction code (ECC)

Error Correction Code (ECC) is a method used to detect and correct errors in data storage or transmission. The goal of the ECC is to ensure data integrity by identifying and fixing errors that may occur during data transfer or while data is being stored in memory.

The ECC works by adding redundant bits to the original data. The extra bits don't carry additional information but are used to detect and correct errors.

When data is read or received, the ECC algorithm checks the data against the redundant bits. If there’s a mismatch, it indicates that an error has occurred.

Depending on an ECC algorithm used, a system can automatically correct certain types of errors. For example, single error correction, double error detection (SECDED) ECC can correct single-bit errors and detect double-bit errors.

There are different types of the ECC such as a hamming code, a Reed-Solomon code, and a Bose–Chaudhuri–Hocquenghem (BCH) code. The hamming code is a common type of the ECC used for single-bit error correction. The Reed-Solomon code is capable of correcting multiple errors. The BCH code is a type of the ECC that can correct multiple random errors and is used in various applications like satellite communications and a flash memory.

The ECC may be used in a memory in servers and high-reliability systems to protect against data corruption. The ECC may be used in storage devices to prevent data loss or corruption. The ECC is crucial in data transmission over unreliable channels, such as satellite links, to ensure data integrity. The ECC is essential in environments where data integrity is critical, and errors can have significant consequences.

In a memory, the purpose of the ECC has been to correct for noise that may randomly occur while reading. The strength, the size and the cost of an ECC block will depend on a number of bits to be corrected and detected. In general, the more capable the ECC approach, the more computationally expensive it is. If done in hardware, that means more silicon area. If done in software, that means more processor cycles.

While noise can show up anywhere, the ECC also can correct deterministic errors, such as those caused by faulty cells. This makes it possible to develop a design and test strategy that leverages some of the ECC bits as a way of handling faulty cells rather than repairing them outright. Given three-bit corrections, for example, one could elect to use two of those bits for repairing errors and one bit for run-time reading noise. This creates some room for push and pull between the amount of sampling done for trimming, the amount of repair capacity in place, the size and strength of the ECC, and the amount of noise to be corrected.

### Example Error Correction code (ECC) Controller

An error correction Code (ECC) controller (or initialization engine) is a specialized hardware component or a function integrated into systems like memory controllers, storage devices, and data communication systems. The ECC controller primary role is to manage error detection and correction processes using ECC algorithms.

The functions of the ECC Controller include error detection, error correction, code generation, memory initialization and management, and reporting.

Error Detection: The ECC controller monitors the data that passes through the ECC controller. The ECC controller checks the data against the error-correcting codes (redundant bits) that have been added to detect any discrepancies or errors.

Error Correction: Upon detecting an error, the ECC controller determines whether the error can be corrected. If it's within the correctable range (e.g., a single-bit error in single error correction, double error detection (SECDED) ECC), the ECC controller corrects the error and ensures that the correct data is used.

Code Generation: When data is written to memory or transmitted, the ECC controller generates the appropriate error-correcting codes for the data. These codes are stored alongside the data or sent with the data for later verification.

Memory Initialization and Management: During system startup, the ECC controller may initialize an ECC memory, ensuring that all error-correcting mechanisms are in place and functioning correctly.

Reporting: The ECC controller often logs and reports any detected and corrected errors to the system. This is important for system administrators to monitor the health of memory or storage systems and take preventive actions if needed.

ECC controllers may be used in memory systems, storage devices, and data communication systems. For example, in servers and high-reliability computing environments, the ECC controllers are integral to memory systems, ensuring that data corruption is detected and corrected in random access memory (RAM). In storage devices, the ECC controllers help maintain data integrity by correcting errors that occur during data storage and retrieval. The ECC controllers in network and communication devices help detect and correct errors during data transmission, ensuring reliable communication even over unreliable or noisy channels. The ECC controllers are vital in any environment where data integrity is critical. The ECC controllers ensure that data errors are caught and corrected, reducing the risk of data corruption, system crashes, or data loss.

### Example Error Correction code (ECC) Memory Initialization

Error correction Code (ECC) memory is a type of computer memory that can detect and correct common types of data corruption. The ECC memory is primarily used in servers, workstations, and other systems where data integrity is crucial.

ECC memory initialization refers to a process of preparing the ECC memory for use when a system is powered on or restarted. This process typically involves: memory testing, setting up error-correcting codes, clearing memory, and verification.

Memory testing: During initialization, the system may perform memory tests to ensure that the ECC functionality is working correctly. This includes checking the memory cells and ensuring that they can store and retrieve data without errors.

Setting up error-correcting codes: The ECC memory stores extra bits alongside the data to allow for error detection and correction. During initialization, these error-correcting codes are set up and verified.

Clearing Memory: In some systems, the ECC memory initialization may involve clearing the memory to ensure that no residual data from previous sessions could cause errors.

Verification: After initialization, the system verifies that the ECC functionality is active and functioning correctly. This ensures that the system is protected from data corruption due to memory errors.

The initialization process is handled by a system's basic input/output system (BIOS) / unified extensible firmware (UEFI) firmware and an ECC controller (or initialization engine), and it usually happens automatically when the system starts up.

Aspects Of Automobile System-On-Chip (SoC) Boot Key Performance Indicator (KPI) Improvement Using Configurable Memory Error Correction code (ECC) Initialization Engine For Internal Memories

A vehicle may include a vehicle control system. The vehicle control system may include one or more computing devices having system-on-a-chips (SoCs) (e.g., one or more electronic control units (ECUs)). A SoC refers to an integrated electronic device including one or more integrated circuit (IC) dies (e.g., chiplets), which combines multiple electronic components (e.g., processors, memories) on a single substrate or in a single package. The SoC may contain circuitry for digital, analog, mixed-signal, and/or radio-frequency functions. A software may control the electronic components of the SoC.

The SoC may include multiple processing domains such as a safety domain (also referred to as a “safety island (SAIL)”). The safety domain may be configured to support (or be capable of performing) vehicle operations of the vehicle up to a lower, a same, or a higher automotive safety integrity level (ASIL). The safety domain may include at least one central processing unit (CPU) and at least one memory.

The safety domain of the SoC may include a static random access memory (SRAM) as a main memory for the CPU of the safety domain. As double date rate (DDR) may not be immediately available, a SRAM with a larger size (e.g., 3 or 4 megabytes) may be used for the safety domain of the SoC. The SRAM may be a random access memory (RAM) that uses latching circuitry (e.g., a flip-flop) to store each bit. The SRAM is volatile memory, and data is lost when power is removed.

The SRAM may be word-wise error correction code (ECC) protected. This may suggest that the SRAM has to be initialized before use, so that any random read/write operations do not trigger any ECC faults in the SRAM.

For example, an ECC code may use both address and data to support a SRAM address decoder fault, which may imply that all-zero initialization of the SRAM is not possible. The all-zero initialization of the SRAM refers to a process of setting all bits in the SRAM cells to zero when a system (e.g., the safety domain) is powered on or reset. This initialization is crucial in many digital systems to ensure that the SRAM starts from a known and consistent state. If the SRAM is not initialized with a correct ECC, then any partial write (WR) data may result in an ECC error.

In order to use the SRAM post power-on mode, the SRAM has to be initialized (e.g., to prevent any ECC failure detection during read-modify-write transactions). The software may initialize the SRAM at different phases (e.g., at a boot start time of the SoC). For example, a primary bootloader (PBL) initializes 100 kilobytes of the SRAM at XO, the PBL also initializes 900 kilobytes of the SRAM at NOM, and for remaining SRAM the software initializes post boot.

The PBL is a software responsible for initial stages of a boot process on a computer or other device such as the safety domain of the SoC. The PBL has to initialize a hardware, load a secondary bootloader (SBL), and pass control over to it. The boot process (e.g., of the safety domain) involves a series of steps that may transition the safety domain from a powered-off state to a fully operational state. This process initializes the safety domain’s components and prepares the safety domain for running application code.

A memory protection unit (MPU) is a computer hardware unit that provides memory (e.g., the SRAM) protection. The MPU is implemented as part of the CPU of the safety domain. The MPU may be a trimmed down version of a memory management unit (MMU) providing only memory protection support. During initialization of the SRAM, MPU programming may need to be changed to prevent speculative read of the SRAM, which may cause ECC failures.

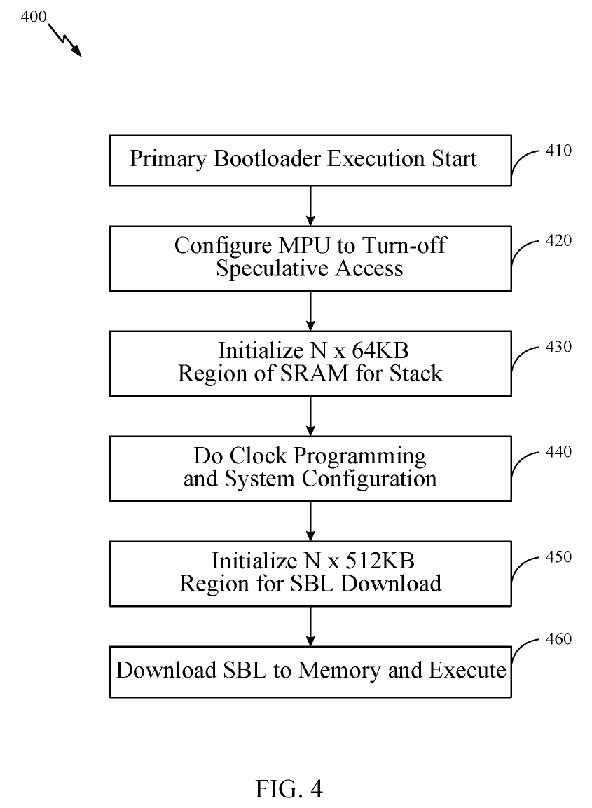

The updating of the MPU programming and software-based initialization of the SRAM may take some time (e.g., around 5-10 milliseconds). Some steps or tasks of the boot process may proceed only after the updating of the MPU programming and/or conclusion of the software-based initialization of the SRAM. For example, as illustrated in a diagram 400 of FIG. 4, at 410, the PBL is executed. At 420, the MPU in configured to turn-off prevent speculative access of the SRAM. At 430, initialize one or more regions (e.g., 64 kilobytes regions) of the SRAM of the SoC for stack. At 440, clock programming and system configuration of the safety domain is performed. At 450, initialize other regions (e.g., 512 kilobytes regions) of the SRAM for SBL download. At 460, the SBL is downloaded and executed.

The time taken for the software-based initialization of the SRAM increases an overall time (e.g., the boot time) for completion of the boot process, which may have a significant negative key performance indicator (KPI) impact for operations related to the vehicle. The time taken for the software-based initialization of the SRAM may be reduced or optimized by adding dedicated hardware for the initialization of the SRAM.

Techniques proposed herein relate to ECC initialization of a memory (e.g., a SRAM) of a safety domain in a SoC in an optimal amount of time. For example, the SRAM may be divided into multiple memory banks of a smaller size (e.g., of 512 kilobytes each). For each memory bank of the SRAM, a dedicated hardware engine (e.g., an ECC initialization engine) may be added or provided for the ECC initialization of the memory bank of the SRAM. The ECC initialization engine may perform the ECC initialization of the memory bank of the SRAM in a shorter amount of time than the ECC initialization of a full SRAM (e.g., since the memory bank has a smaller size than the full SRAM).

Also, multiple ECC initialization engines for the multiple memory banks of the SRAM may be executed or run in parallel (e.g., for their respective memory banks) at a same time when a PBL is executed. The simultaneous ECC initialization of the multiple memory banks of the SRAM, instead of the ECC initialization of the full SRAM, may save on a total time to initialize the full SRAM.

The ECC initialization engine may also be able to perform the ECC initialization of a full memory bank of the SRAM or a portion of the memory bank of the SRAM (e.g., such as 32 kilobytes, 64 kilobytes). This gives flexibility to a software implementing and realizing the ECC initialization engine to initialize different portions of the SRAM during different boot phases.

Particular aspects of the subject matter described in this disclosure can be implemented to realize one or more of the following potential advantages. In some examples, the described techniques provide overall time saving (e.g., of 5-10 milliseconds) for boot KPI, flexibility for the software to tune and improve performance by running the ECC initialization engines in parallel for the multiple memory banks of the SRAM, flexibility for the software to initialize only a portion of the memory bank of the SRAM to allow different phases of the boot, and flexibility for the software to initialize the SRAM with predetermined data (e.g., not only with zero).

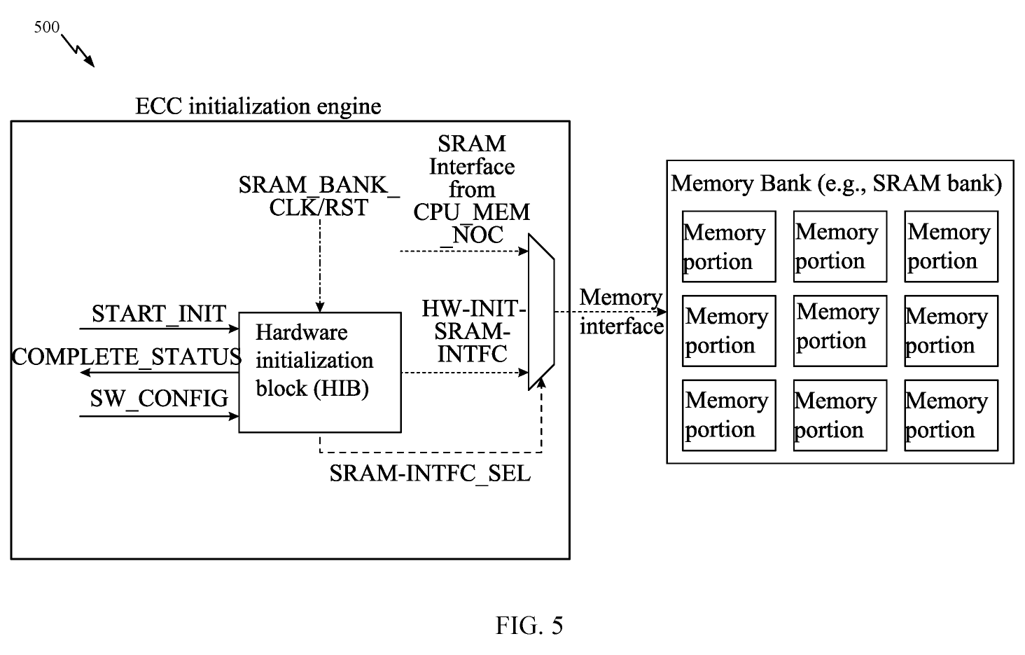

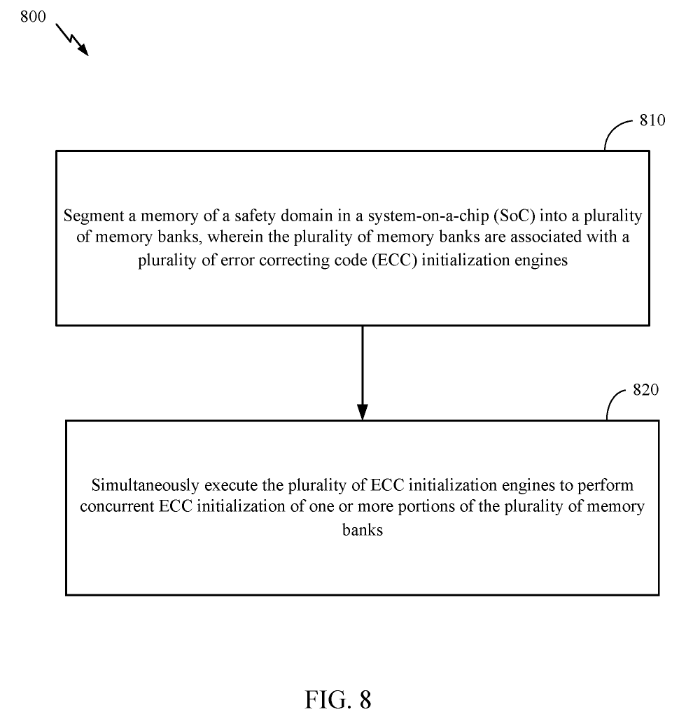

The techniques proposed herein for the concurrent ECC initialization of the multiple memory banks of the SRAM may be understood with reference to FIG. 5 - FIG. 8.

FIG. 5 illustrates a diagram 500 depicting ECC initialization of a memory bank (e.g., which is small portion of a SRAM) using a dedicated ECC initialization engine for the memory bank. In one aspect, the memory bank of the SRAM may be included in the vehicle 100 of FIG. 1. In another aspect, the memory bank of the SRAM may be included in the safety domain 202b of the SoC 200 of FIG. 2. In another aspect, the memory bank of the SRAM may be managed by the SoC-based ECU 300a in FIG. 3.

The SRAM may be an ECC memory designed to detect and correct errors in data stored in the SRAM. The initialization of the ECC memory is a bit more involved than a standard memory because it requires specific steps to ensure that the ECC features are properly configured and operational.

The memory bank of the SRAM may be associated with the ECC initialization engine using a memory interface. The ECC initialization engine may include a hardware initialization block (HIB), which may be responsible for setting up and configuring hardware components (e.g., the SRAM) when a system (e.g., the safety domain 202b of the SoC 200 of FIG. 2) starts up. The purpose of the HIB is to ensure that all necessary hardware elements (e.g., at least the SRAM) are correctly initialized before the system begins normal operation.

The HIB may set up initial values and configurations for various hardware components, such as the SRAM, registers, and input/output ports. This might include setting clock speeds, configuring communication interfaces, and setting up interrupt vectors. The HIB may ensure that the hardware components such as the SRAM are initialized in a correct order. Some components might depend on others being initialized first, so the HIB handles these dependencies. The HIB may include diagnostic routines to check the status of hardware components such as the SRAM and ensure they are functioning correctly before the system proceeds to its main tasks. The HIB may be a part of a startup code or a bootloader that runs immediately after the system is powered on or reset. It typically runs before a main application code.

The HIB may receive multiple configurations, instructions and signals. The received configurations, instructions and signals may include an instruction to start initialization, a software configuration for the HIB, and/or a clock signal. The HIB may output a status signal indicating a status of the initialization (e.g., the initialization has been completed). The HIB may be associated with the memory bank of the SRAM and/or a CPU (e.g., of the safety domain 202b of the SoC 200 of FIG. 2) via one or more interfaces.

The memory bank of the SRAM may include multiple portions. In one aspect, the ECC initialization engine may perform initialization of a full memory bank of the SRAM.

In another aspect, the ECC initialization engine may perform initialization of one or more portions of the memory bank during different boot phases (e.g., during a boot process of the safety domain 202b of the SoC 200 of FIG. 2). For example, the ECC initialization engine may perform initialization of a first portion of the memory bank during a first boot phase (e.g., during the boot process of the safety domain 202b of the SoC 200 of FIG. 2) and the ECC initialization engine may perform initialization of a second portion of the memory bank during a second boot phase (e.g., during the boot process of the safety domain 202b of the SoC 200 of FIG. 2).

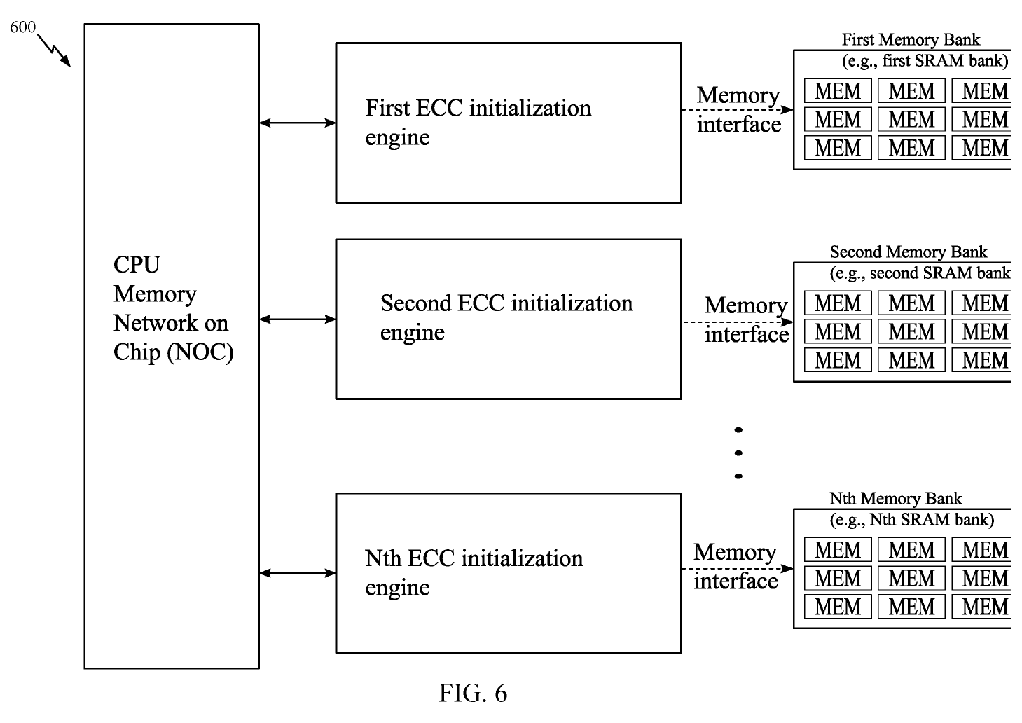

FIG. 6 illustrates a diagram 600 depicting concurrent ECC initialization of multiple memory banks (e.g., which are portions of a SRAM) using multiple ECC initialization engines, in accordance with certain aspects of the present disclosure. In one aspect, the multiple memory banks of the SRAM may be included in the vehicle 100 of FIG. 1. In another aspect, the multiple memory banks of the SRAM may be included in the safety domain 202b of the SoC 200 of FIG. 2. In another aspect, the multiple memory banks of the SRAM may be managed by the SoC-based ECU 300a in FIG. 3.

The multiple ECC initialization engines may include at least a first ECC initialization engine and a second ECC initialization engine. The multiple ECC initialization engines are associated with a CPU memory network on chip (NoC), which is an in-chip network in a SoC (e.g., the SoC-based ECU 300a in FIG. 3) that connects components and routes data packets among them using switches.

The multiple ECC initialization engines are associated with the multiple memory banks of the SRAM via memory interfaces. The multiple memory banks of the SRAM may include at least a first memory bank and a second memory bank. Each memory bank of the SRAM may include multiple portions. For example, the first ECC initialization engine is associated with the first memory bank of the SRAM and the second ECC initialization engine is associated with the second memory bank of the SRAM.

Each of the multiple memory banks of the SRAM may be initialized in parallel without blocking any CPU (e.g., of the safety domain 202b of the SoC 200 of FIG. 2) access to a boot read only memory (BootROM). The BootROM may be a type of non-volatile memory that contains an initial code executed when a system (e.g., the safety domain 202b of the SoC 200 of FIG. 2) is powered on or reset. This code is crucial for the system’s startup process, as it performs essential tasks such as hardware initialization, system checks, and loading an operating system or application software.

For example, for initialization, at a same time or simultaneously, the first ECC initialization engine may perform initialization of the first memory bank of the SRAM and the second ECC initialization engine may perform initialization of the second memory bank of the SRAM. The initialization of the different memory banks of the SRAM at the same time may reduce an overall time for the initialization of a full SRAM.

In certain aspects, each memory bank of the SRAM may be selectively initialized with a smaller region size in case a particular memory bank area is needed early to support boot process.

For example, the first ECC initialization engine may perform initialization of a first portion of the first memory bank of the SRAM at a first time and the first ECC initialization engine may perform initialization of a second portion of the first memory bank of the SRAM at a second time. The second time is after the first time.

In another example, the second ECC initialization engine may perform initialization of a first portion of the second memory bank of the SRAM at a first time and the second ECC initialization engine may perform initialization of a second portion of the second memory bank of the SRAM at a second time. The second time is after the first time.

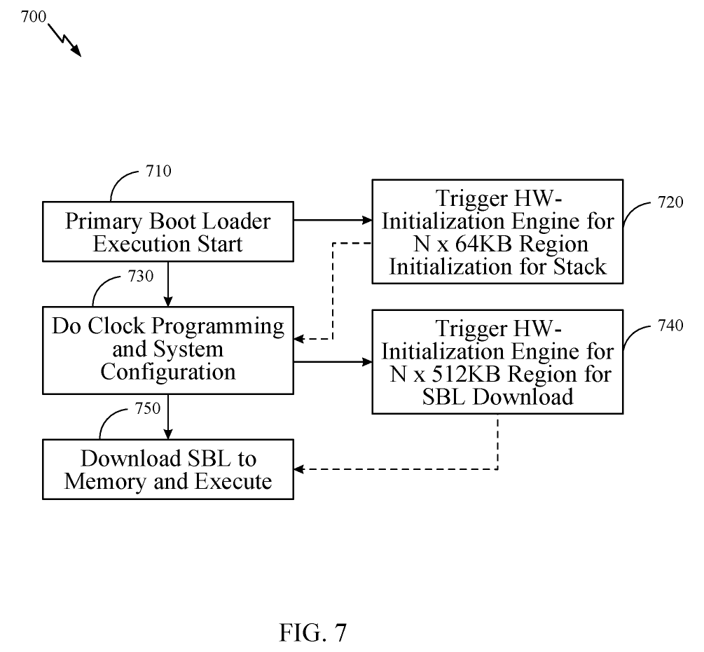

FIG. 7 depicts an example process 700 illustrating triggering of concurrent ECC initialization of multiple memory banks (e.g., of a SRAM) in a SoC based on an execution of a PBL, in accordance with certain aspects of the present disclosure. In one aspect, the multiple memory banks of the SRAM may be included in the vehicle 100 of FIG. 1. In another aspect, the multiple memory banks of the SRAM may be included in the safety domain 202b of the SoC 200 of FIG. 2. In another aspect, the multiple memory banks of the SRAM may be managed by the SoC-based ECU 300a in FIG. 3.

As depicted, at 710, a software executes the PBL at a time T1. At the same time T1 and in parallel (e.g., at 720), a hardware initialization of one or more memory banks or one or more regions of the memory banks (e.g., 64 kilobytes regions) of the SRAM for stack is triggered. While hardware initialization of the memory banks of the SRAM is happening, other processes by the software may continue. For example, at 730, clock programming and system configuration (e.g., for the safety domain 202b of the SoC 200 of FIG. 2) is performed at a time T2. At the same time T2 and in parallel (e.g., at 740), the hardware initialization of other regions of the memory banks (e.g., 512 kilobytes regions) of the SRAM for SBL download is triggered. After the hardware initialization of the SRAM is completed, at 750, the SBL is downloaded and executed.

### Example Method For Error Correction code (ECC) I initialization Of Memory Banks

FIG. 8 depicts an example method 800 for error correction code (ECC) initialization of memory banks, in accordance with certain aspects of the present disclosure.

Method 800 begins at 810 with segmenting a memory of a safety domain in a system-on-a-chip (SoC) into a plurality of memory banks. The plurality of memory banks are associated with a plurality of ECC initialization engines.

Method 800 then proceeds to 820 with simultaneously executing the plurality of ECC initialization engines to perform concurrent ECC initialization of one or more portions of the plurality of memory banks.

In certain aspects, each ECC initialization engine of the plurality of ECC initialization engines may be configured to perform the ECC initialization of a corresponding memory bank of the plurality of memory banks.

In certain aspects, each memory bank of the plurality of memory banks may include a plurality of portions.

In certain aspects, the method 800 further includes configuring the plurality of ECC initialization engines to perform the ECC initialization of all portions of the plurality of portions of the plurality of memory banks.

In certain aspects, the method 800 further includes configuring the plurality of ECC initialization engines to perform the ECC initialization of a subset of the plurality of portions of the plurality of memory banks.

In certain aspects, the plurality of portions of each memory bank of the plurality of memory banks may have a same size.

In certain aspects, the plurality of portions of each memory bank of the plurality of memory banks may have different sizes.

In certain aspects, the method 800 further includes configuring each ECC initialization engine of the plurality of ECC initialization engines to perform the ECC initialization of a corresponding memory bank of the plurality of memory banks based on a size of the corresponding memory bank.

In certain aspects, the method 800 further includes triggering simultaneous execution of the plurality of ECC initialization engines to perform the concurrent ECC initialization of the one or more portions of the plurality of memory banks at a same time.

In certain aspects, the method 800 further includes triggering execution of the plurality of ECC initialization engines at different times to perform the ECC initialization of the one or more portions of the plurality of memory banks at the different times.

In certain aspects, each ECC initialization engine of the plurality of ECC initialization engines is a hardware device including an initialization block including a code for the ECC initialization of a corresponding memory bank of the plurality of memory banks.

The various operations of methods described above may be performed by any suitable means capable of performing the corresponding functions. The means may include various hardware and/or software component(s) and/or module(s), including, but not limited to a circuit, an application specific integrated circuit (ASIC), or one or more processors.

### Example Clauses

Implementation examples are described in the following numbered clauses:

Clause 1: A method, comprising: segmenting a memory of a safety domain in a system-on-a-chip (SoC) into a plurality of memory banks, wherein the plurality of memory banks are associated with a plurality of error correction code (ECC) initialization engines; and simultaneously executing the plurality of ECC initialization engines to perform concurrent ECC initialization of one or more portions of the plurality of memory banks.

Clause 2: The method of clause 1, wherein each ECC initialization engine of the plurality of ECC initialization engines is configured to perform the ECC initialization of a corresponding memory bank of the plurality of memory banks.

Clause 3: The method of any one of clauses 1-2, wherein each memory bank of the plurality of memory banks comprises a plurality of portions.

Clause 4: The method of clause 3, further comprising configuring the plurality of ECC initialization engines to perform the ECC initialization of all portions of the plurality of portions of the plurality of memory banks.

Clause 5: The method of clause 3, further comprising configuring the plurality of ECC initialization engines to perform the ECC initialization of a subset of the plurality of portions of the plurality of memory banks.

Clause 6: The method of clause 3, wherein the plurality of portions of each memory bank of the plurality of memory banks have a same size.

Clause 7: The method of clause 3, wherein the plurality of portions of each memory bank of the plurality of memory banks have different sizes.

Clause 8: The method of any one of clauses 1-7, further comprising configuring each ECC initialization engine of the plurality of ECC initialization engines to perform the ECC initialization of a corresponding memory bank of the plurality of memory banks based on a size of the corresponding memory bank.

Clause 9: The method of any one of clauses 1-8, further comprising triggering simultaneous execution of the plurality of ECC initialization engines to perform the concurrent ECC initialization of the one or more portions of the plurality of memory banks at a same time.

Clause 10: The method of any one of clauses 1-9, further comprising triggering execution of the plurality of ECC initialization engines at different times to perform the ECC initialization of the one or more portions of the plurality of memory banks at the different times.

Clause 11: The method of any one of clauses 1-10, wherein each ECC initialization engine of the plurality of ECC initialization engines is a hardware device comprising an initialization block comprising a code for the ECC initialization of a corresponding memory bank of the plurality of memory banks.

Clause 12: An apparatus, comprising: a memory comprising instructions; and one or more processors configured, individually or in any combination, to execute the instructions and cause the apparatus to perform a method in accordance with any one of Clauses 1-11.

Clause 13: An apparatus, comprising means for performing a method in accordance with any one of Clauses 1-11.

Clause 14: A non-transitory computer-readable medium comprising executable instructions that, when executed by one or more processors of an apparatus, cause the apparatus to perform a method in accordance with any one of Clauses 1-11.

Clause 15: A computer program product embodied on a computer-readable storage medium comprising code for performing a method in accordance with any one of Clauses 1-11.

### Additional Considerations

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B and object B touches object C, then objects A and C may still be considered coupled to one another—even if objects A and C do not directly physically touch each other. For instance, a first object may be coupled to a second object even though the first object is never directly physically in contact with the second object. The terms “circuit” and “circuitry” are used broadly and intended to include both hardware implementations of electrical devices and conductors that, when connected and configured, enable the performance of the functions described in the present disclosure, without limitation as to the type of electronic circuits.

The apparatus and methods described in the detailed description are illustrated in the accompanying drawings by various blocks, modules, components, circuits, steps, processes, algorithms, etc. (collectively referred to as “elements”). These elements may be implemented using hardware, for example.

One or more of the components, steps, features, and/or functions illustrated herein may be rearranged and/or combined into a single component, step, feature, or function or embodied in several components, steps, or functions. Additional elements, components, steps, and/or functions may also be added without departing from features disclosed herein. The apparatus, devices, and/or components illustrated herein may be configured to perform one or more of the methods, features, or steps described herein.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover at least: a, b, c, a-b, a-c, b-c,and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

It is to be understood that the claims are not limited to the precise configuration and components illustrated above. Various modifications, changes, and variations may be made in the arrangement, operation, and details of the methods and apparatus described above without departing from the scope of the claims.

1. A method, comprising:
segmenting a memory of a safety domain in a system-on-a-chip (SoC) into a plurality of memory banks, wherein the plurality of memory banks are associated with a plurality of error correction code (ECC) initialization engines; and
simultaneously executing the plurality of ECC initialization engines to perform concurrent ECC initialization of one or more portions of the plurality of memory banks.

2. The method of claim 1, wherein each ECC initialization engine of the plurality of ECC initialization engines is configured to perform the ECC initialization of a corresponding memory bank of the plurality of memory banks.

3. The method of claim 1, wherein each memory bank of the plurality of memory banks comprises a plurality of portions.

4. The method of claim 3, further comprising configuring the plurality of ECC initialization engines to perform the ECC initialization of all portions of the plurality of portions of the plurality of memory banks.

5. The method of claim 3, further comprising configuring the plurality of ECC initialization engines to perform the ECC initialization of a subset of the plurality of portions of the plurality of memory banks.

6. The method of claim 3, wherein the plurality of portions of each memory bank of the plurality of memory banks have a same size.

7. The method of claim 3, wherein the plurality of portions of each memory bank of the plurality of memory banks have different sizes.

8. The method of claim 1, further comprising configuring each ECC initialization engine of the plurality of ECC initialization engines to perform the ECC initialization of a corresponding memory bank of the plurality of memory banks based on a size of the corresponding memory bank.

9. The method of claim 1, further comprising triggering simultaneous execution of the plurality of ECC initialization engines to perform the concurrent ECC initialization of the one or more portions of the plurality of memory banks at a same time.

10. The method of claim 1, further comprising triggering execution of the plurality of ECC initialization engines at different times to perform the ECC initialization of the one or more portions of the plurality of memory banks at the different times.

11. The method of claim 1, wherein each ECC initialization engine of the plurality of ECC initialization engines is a hardware device comprising an initialization block comprising a code for the ECC initialization of a corresponding memory bank of the plurality of memory banks.

12. An apparatus, comprising:
a safety domain with a memory; and
one or more processors coupled to the safety domain and configured to:
segment the memory of the safety domain into a plurality of memory banks, wherein the plurality of memory banks are associated with a plurality of error correction code (ECC) initialization engines; and
simultaneously execute the plurality of ECC initialization engines to perform concurrent ECC initialization of one or more portions of the plurality of memory banks.

13. The apparatus of claim 12, wherein each ECC initialization engine of the plurality of ECC initialization engines is configured to perform the ECC initialization of a corresponding memory bank of the plurality of memory banks.

14. The apparatus of claim 12, wherein each memory bank of the plurality of memory banks comprises a plurality of portions.

15. The apparatus of claim 14, wherein the one or more processors are configured to configure the plurality of ECC initialization engines to perform the ECC initialization of all portions of the plurality of portions of the plurality of memory banks.

16. The apparatus of claim 14, wherein the one or more processors are configured to configure the plurality of ECC initialization engines to perform the ECC initialization of a subset of the plurality of portions of the plurality of memory banks.

17. The apparatus of claim 14, wherein the plurality of portions of each memory bank of the plurality of memory banks have a same size.

18. The apparatus of claim 14, wherein the plurality of portions of each memory bank of the plurality of memory banks have different sizes.

19. The apparatus of claim 12, wherein the one or more processors are configured to configure each ECC initialization engine of the plurality of ECC initialization engines to perform the ECC initialization of a corresponding memory bank of the plurality of memory banks based on a size of the corresponding memory bank.

20. An apparatus, comprising:
means for segmenting a memory of a safety domain in a system-on-a-chip (SoC) into a plurality of memory banks, wherein the plurality of memory banks are associated with a plurality of error correction code (ECC) initialization engines; and
means for simultaneously executing the plurality of ECC initialization engines to perform concurrent ECC initialization of one or more portions of the plurality of memory banks.
